(19) United States
(12) Patent Application Publication
(10) Pub. No.: US 2013/0268789 A1
(43) Pub. Date: Oct. 10, 2013

(54) ELECTRONIC DEVICE AND METHOD OF MANAGING POWER OF THE SAME

(71) Applicant: Seung-soo YANG, Hwaseong-si (KR)

(72) Inventor: Seung-soo YANG, Hwaseong-si (KR)

(21) Appl. No.: 13/673,332

(22) Filed: Nov. 9, 2012

(30) Foreign Application Priority Data
Apr. 5, 2012 (KR) 10-2012-0035597

(51) Int. Cl. G06F 1/32

(52) U.S. Cl. 713/323

(57) ABSTRACT

An electronic device includes a universal serial bus (USB) controller and a USB power managing unit. The USB controller transmits data to an external electronic device or receives data from the external electronic device during an active mode. The USB power managing unit manages power of the USB controller in response to a state signal while the

USB controller is operating in the active mode. The state signal is based on a communication state of the USB controller.

### CROSS-REFERENCE TO RELATED APPLICATIONS

This application claims priority under 35 USC §119 to Korean Patent Application No. 10-2012-0035597, filed on Apr. 5, 2012, the disclosure of which is incorporated by reference in its entirety.

### TECHNICAL FIELD

Exemplary embodiments of the inventive concept relate to an electronic device and a method of managing power of the same, and more particularly, to an electronic device and a method of managing power of the same which may reduce power consumption while a communication channel between the electronic device and an external device is in an active state.

### DISCUSSION OF THE RELATED ART

As electronic devices become more mobile and more powerful, the need to efficiently manage the power consumption of these electronic devices has grown.

### SUMMARY

Exemplary embodiments of the inventive concept provide an electronic device and a method of managing power of the same which may reduce power consumption while a communication channel with an external device is in an active state.

According to an exemplary embodiment of the inventive concept, an electronic device includes a universal serial bus (USB) controller and a USB power managing unit. The USB controller is configured to transmit data to an external electronic device or receive data from the external electronic device during an active mode. The USB power managing unit is configured to manage power of the USB controller in response to a state signal while the USB controller is operating in the active mode. The state signal is based on a communication state of the USB controller.

According to an exemplary embodiment of the inventive concept, a system includes a USB host device and a USB client device. The USB host device and the USB client device are connected to each other via a USB connection. The USB client device includes a USB power managing unit configured to reduce or disable power or a clock signal of at least one functional block of the USB client device based on a communication state between the USB client device and the USB host device while in an active mode.

According to an exemplary embodiment of the inventive concept, an electronic device includes a USB controller configured to control data communication between the electronic device and an external electronic device, and a USB port configured to transmit data to the external electronic device or receive data from the external electronic device under control of the USB controller. The USB controller is configured to reduce or disable power or a clock signal of a functional block of the USB controller utilized for data reception while data is transmitted from the USB controller to the external electronic device, and reduce or disable power or a clock signal of a functional block of the USB controller utilized for data transmission while data is received at the USB controller from the external electronic device.

According to an exemplary embodiment of the inventive concept, a method of managing power of an electronic device includes connecting the electronic device to an external electronic device via a USB connection, transmitting data from the electronic device to the external electronic device, or receiving data at the electronic device from the external electronic device via the USB connection under control of a USB controller of the electronic device, and reducing power of the USB controller while data is being transmitted from the electronic device to the external electronic device or received at the electronic device from the external electronic device.

According to an exemplary embodiment of the inventive concept, a method of managing power of an electronic device includes generating a state signal at a USB controller, wherein the state signal indicates a communication state of the USB controller, transmitting the state signal from the USB controller to a USB power managing unit, generating a power control signal at the USB power managing unit based on the state signal, transmitting the power control signal from the USB power managing unit to the USB controller, and managing power of the USB controller based on the power control signal while the USB controller is in an active mode, wherein the USB controller transmits or receives data while in the active mode.

### BRIEF DESCRIPTION OF THE DRAWINGS

The above and other features of the present inventive concept will become more apparent by describing in detail exemplary embodiments thereof with reference to the accompanying drawings, in which:

FIG. 1 is a block diagram illustrating an electronic device, according to an exemplary embodiment of the inventive concept.

FIG. 2 is a block diagram illustrating a universal serial bus (USB) controller of FIG. 1, according to an exemplary embodiment of the inventive concept.

FIGS. 3A through 3C are block diagrams illustrating the USB controller of FIG. 2, according to exemplary embodiments of the inventive concept.

FIG. 4 is a graph illustrating an operation of a USB power managing unit of the electronic device of FIG. 1, according to an exemplary embodiment of the inventive concept.

FIGS. 5 through 8 are block diagrams illustrating states of functional blocks of a USB controller according to a power control signal of FIG. 4, according to exemplary embodiments of the inventive concept.

FIG. 9 is a graph illustrating an operation of a USB power managing unit, according to an exemplary embodiment of the inventive concept.

FIG. 10 is a block diagram illustrating an electronic device, according to an exemplary embodiment of the inventive concept.

FIGS. 11 and 12 are diagrams illustrating an implementation of power management of the electronic device of FIG. 10, according to an exemplary embodiment of the inventive concept.

FIG. 13 is a block diagram illustrating the electronic device, according to an exemplary embodiment of the inventive concept.

FIG. 14 is a diagram illustrating an implementation of power management of the electronic device of FIG. 13, according to an exemplary embodiment of the inventive concept.

FIG. 15 is a diagram illustrating a USB physical layer of the electronic device of FIG. 2, according to an exemplary embodiment of the inventive concept.

FIGS. 16 through 19 are diagrams illustrating an implementation of power management of the USB controller of FIG. 15, according to exemplary embodiments of the inventive concept.

FIG. 20 is a diagram illustrating a system including an electronic device, according to an exemplary embodiment of the inventive concept.

FIG. 21 is a diagram illustrating the USB physical layer of the electronic device of FIG. 1, according to an exemplary embodiment of the inventive concept.

FIG. 22 is a diagram illustrating an implementation of power management of the electronic device of FIG. 10, according to an exemplary embodiment of the inventive concept.

FIGS. 23A through 24E are diagrams illustrating detecting a communication state of an electronic device, according to exemplary embodiments of the inventive concept.

FIG. 25 is a diagram illustrating an electronic device, according to an exemplary embodiment of the inventive concept.

FIG. 26 is a flowchart illustrating a method of managing power of an electronic device, according to an exemplary embodiment of the inventive concept.

FIG. 27 is a diagram illustrating an implementation of power management of an electronic device, according to an exemplary embodiment of the inventive concept.

### DETAILED DESCRIPTION OF THE EXEMPLARY EMBODIMENTS

Exemplary embodiments of the inventive concept will be described more fully hereinafter with reference to the accompanying drawings. Like reference numerals may refer to like elements throughout the accompanying drawings.

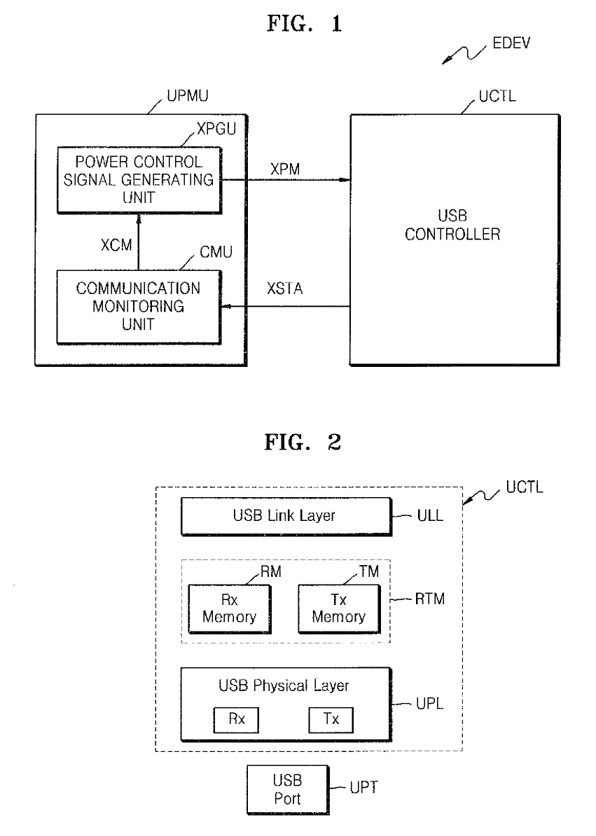

FIG. 1 is a block diagram illustrating an electronic device EDEV according to an exemplary embodiment of the inventive concept.

Referring to FIG. 1, the electronic device EDEV includes a universal serial bus (USB) controller UCTL and a USB power managing unit UPMU. Examples of the electronic device EDEV may include a camera, a camcorder, a game player, a recorder, a computer, a scanner, a printer, a mobile phone, a wired phone, a storage device, a keyboard, a mouse, and a display device which may communicate with another electronic device during USB communication. Since plug and play functionality of USB devices improves the convenience of an end user, USB communication is widely used.

The USB controller UCTL communicates with another electronic device based on a USB protocol via a communication channel. As used herein, the term communication refers to transmitting or receiving data. The communication channel may be, for example, a wired connection (e.g., a USB cable) or a wireless connection channel. The USB controller UCTL may include a USB link layer ULL and a USB physical layer UPL, as shown in FIG. 2.

FIG. 2 is a block diagram illustrating the USB controller UCTL of FIG. 1, according to an exemplary embodiment of the inventive concept. Referring to FIG. 2, the USB link layer ULL may perform an encapsulation operation. The encapsulation operation involves formatting data into packets by including a packet ID or a cyclic redundancy check (CRC) field in bytes. The USB link layer ULL may further perform a de-encapsulation operation. The de-encapsulation operation involves extracting the bytes from the packets according to a USB protocol specification.

The USB physical layer UPL may perform a signaling operation, which converts parallel data to serial data, and serial data to parallel data, according to the USB protocol specification. The USB physical layer UPL may include a transmitter Tx and a receiver Rx. The transmitter Tx may convert serial data processed by the USB link layer ULL into parallel data. The receiver Rx may perform clock data recovery (CDR) on external serial data to recover a clock signal, convert the serial data into parallel data, and transmit the parallel data to the USB link layer ULL. Although the transmitter Tx and the receiver Rx are shown as separate components in the USB physical layer UPL in FIG. 2, exemplary embodiments are not limited thereto. For example, in an exemplary embodiment, a single component disposed in the USB physical layer UPL may include both the transmitter Tx and the receiver Rx.

The USB controller UCTL may further include a transmission/reception memory RTM. The transmission/reception memory RTM may buffer data between the USB link layer ULL and the USB physical layer UPL. The transmission/reception memory RTM may include, for example, a transmission memory TM and a reception memory RM. Each of the transmission memory TM and the reception memory RM may use a first in, first out (FIFO) policy in which data stored in a queue is sequentially output.

Still referring to FIG. 2, a USB port UPT of the electronic device EDEV may output data processed by the transmitter Tx and transmit external data to the receiver Rx.

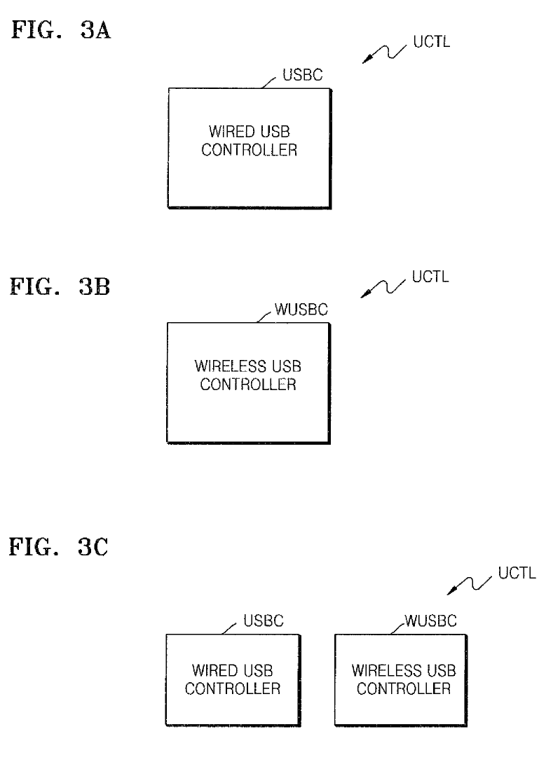

The USB controller UCTL may transmit or receive data during wired or wireless communication. For example, the USB controller UCTL of FIG. 1 may be a wired USB controller USBC that communicates with an external electronic device during wired USB communication, as shown in FIG. 3A. In this case, the USB port UPT of FIG. 2 may transmit or receive data via a USB cable connected to the USB port UPT. Alternatively, the USB controller UCTL of FIG. 1 may be a wireless USB controller WUSBC that communicates with an external electronic device during wireless USB communication, as shown in FIG. 3B. Alternatively, the USB controller UCTL of FIG. 1 may include both the wired USB controller USBC and the wireless USB controller

WUSBC, as shown in FIG. 3C. The wireless communication may be, for example, ultra-wideband (UWB) communication.

When the USB cable is connected to the USB port UPT of FIG. 2, the USB controller UCTL may transmit or receive data via the wired USB controller USBC. When the USB cable is not connected to the USB port UPT of FIG. 2, the USB controller UCTL may transmit or receive data via the wireless USB controller WUSBC. In exemplary embodiments, the USB controller UCTL may transmit or receive data via the wireless USB controller WUSBC while a USB cable is connected to the USB port UPT.

Referring back to FIG. 1, the USB power managing unit UPMU of the electronic device EDEV manages power of the USB controller UCTL, and may reduce power consumption. The USB power managing unit UPMU may include a communication monitoring unit CMU and a power control signal generating unit XPGU.

When the USB controller UCTL is in an active mode, the communication monitoring unit CMU receives a state signal XSTA indicating a communication state between the USB controller UCTL and an external electronic device, and outputs a communication monitoring signal XCM. The term active mode refers to a state in which data is being communicated between the USB controller UCTL and the external electronic device, or is ready to be communicated between the USB controller UCTL and the external electronic device. The external electronic device may be, for example, a host device or a client device that is electrically connected to the USB controller UCTL. When the USB controller UCTL is not in an active mode, it may be in a power saving mode. In the power saving mode, a wired or wireless communication line between the USB controller UCTL and the external electronic device may be inactive, and data may not be communicated between the USB controller UCTL and the external electronic device until the communication line is activated.

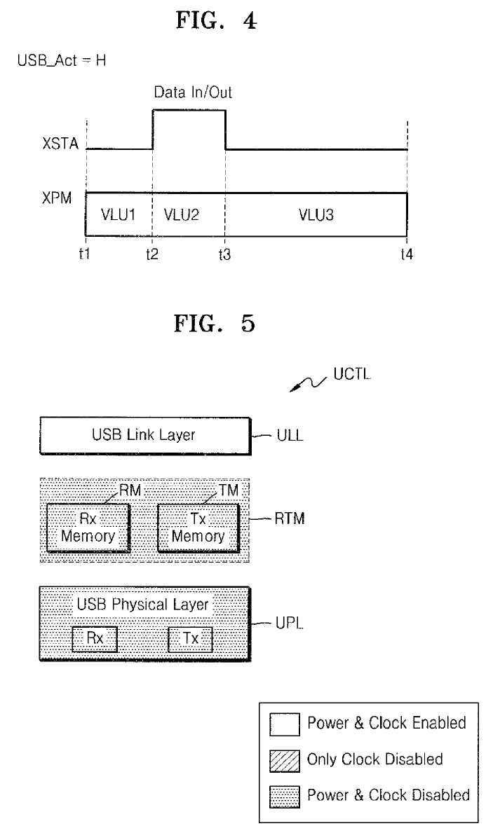

When the USB controller UCTL is in an active mode (USB_Act=H), as shown in FIG. 4, the state signal XSTA may indicate whether data is input to or output from the USB controller UCTL. The state signal XSTA and the communication monitoring signal XCM may include the same content. Accordingly, the state signal XSTA and the communication monitoring signal XCM may be interchangeably used.

The power control signal generating unit XPGU receives the communication monitoring signal XCM and generates a power control signal XPM that controls the power state of the USB controller UCTL. The power efficiency of the USB controller may be improved in response to the power control signal XPM.

For example, when the USB controller UCTL is in an active mode (USB_Act=H), as shown in FIG. 4, the power control signal XPM may have a first value VLU1 in a period between a time t1 and a time t2, where data is not input to or output from the USB controller UCTL. For example, power or a clock signal of a functional block responsible for data transmission or data reception of the USB controller UCTL may be disabled by the power control signal XPM when the power control signal XPM has the first value VLU1. For example, as shown in FIG. 5, power and a clock signal of the USB physical layer UPL and the transmission/reception memory RTM may be disabled by the power control signal XPM having the first value VLU1.

Referring back to FIG. 4, when USB communication occurs in the period between the time t2 and a time t3, for example, when data is input to the USB controller UCTL from an external electronic device or data is output to the external electronic device from the USB controller UCTL, the power control signal XPM has a second value VLU2, which may be transmitted to the USB controller UCTL. For example, when the power control signal XPM has the second value VLU2, data may be input or output during wired USB communication via the USB cable, or data may be input or output during wireless USB communication.

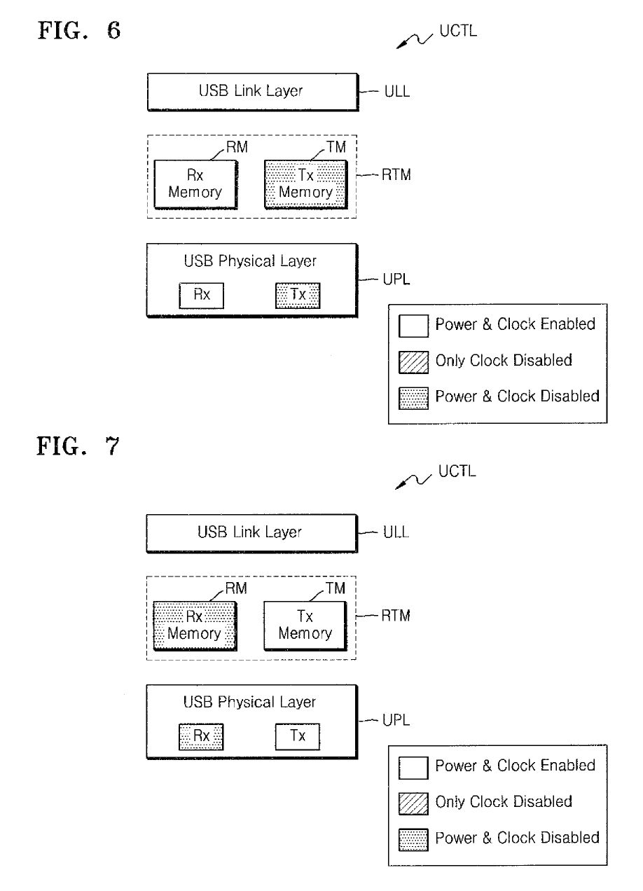

For example, when data is input to the USB controller UCTL from the external electronic device, since data transmission and data reception do not simultaneously occur according to a USB protocol, power and a clock signal of the transmission memory TM and the transmitter Tx may be disabled by the power control signal XPM having the second value VLU2, as shown in FIG. 6. Alternatively, when data is output to the external electronic device from the USB controller UCTL, power and a clock signal of the reception memory RM and the receiver Rx may be disabled by the power control signal XPM having the second value VLU2, as shown in FIG. 7.

Referring back to FIG. 4, after data transmission or data reception is completed in a period between the time t2 and the time t3, when data is no longer input or output in a period between the time t3 and a time t4, the power control signal generating unit XPGU may transmit the power control signal XPM having a third value VLU3 to the USB controller UCTL. The USB controller UCTL may disable power or a clock signal of a corresponding functional block in response to the power control signal XPM having the third value VLU3.

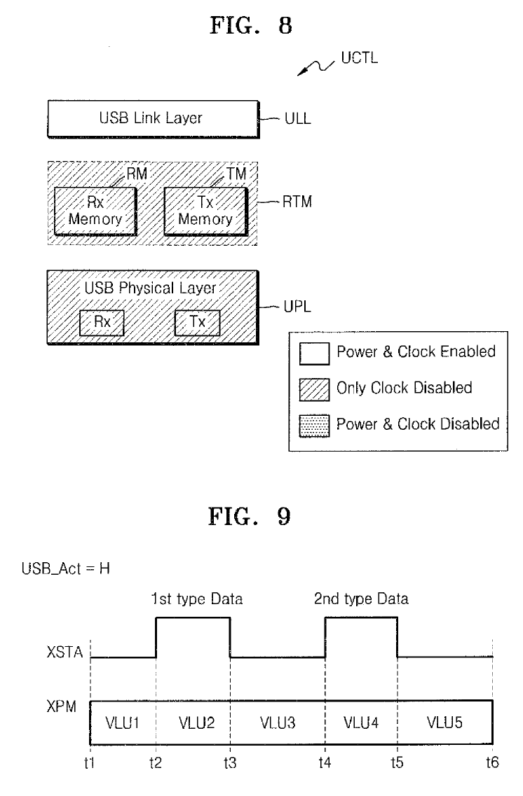

For example, the third value VLU3 may be the same as the first value VLU1. In this case, as described with reference to FIG. 5, power and a clock signal of the USB physical layer UPL and the transmission/reception memory RTM may be disabled. Alternatively, the third value VLU3 may be different from the first value VLU1. For example, although data transmission or data reception does not occur in the period between the time t3 and the time t4, power supply may be maintained, and a clock signal may be disabled. When the power supply is maintained and the clock signal is disabled, the USB controller UCTL is prepared for future data transmission or data reception. For example, as shown in FIG. 8, power supply to the transmission/reception memory RTM and the USB physical layer UPL may be maintained, and only a clock signal of the transmission/reception memory RTM and the USB physical layer UPL may be disabled by the power control signal XPM having the third value VLU3. Functional blocks of the USB controller UCTL operate in synchronization with clock signals applied thereto. As a result, when no clock signal is applied, each of the functional blocks stops operating, thereby reducing power consumption.

In an active mode, the electronic device EDEV may vary a level of power by varying a value of the power control signal XPM in periods where data transmission or data reception do not occur. For example, the electronic device EDEV may set a value of the power control signal XPM of FIG. 5 such that both power and a clock signal are disabled, and may set a value of the power control signal XPM of FIG. 8 such that only a clock signal is disabled. The electronic device EDEV may select the value of the power control signal XPM corresponding to a current communication state from among the values of the power control signal XPM. That is, different values of the power control signal XPM correspond to different communication states between the electronic device EDEV and the external electronic device.

Power management is performed according to a result obtained by monitoring a communication state between the electronic device EDEV and the external electronic device via a wired or wireless channel. However, exemplary embodiments are not limited thereto. For example, the USB power managing unit UPMU may perform power management of the USB controller UCTL according to a type of data (e.g., a first type of data or a second type of data) input to or output from the USB controller UCTL when the USB controller UCTL is in an active mode (USB_Act=H), as shown in FIG. 9.

Referring to FIGS. 1 and 9, the power control signal generating unit XPGU may generate the power control signal XPM having the second value VLU2 or a fourth value VLU4 in response to information indicating a type of data included in the state signal XSTA. For example, the power control signal XPM having the second value VLU2 may be generated in the period between the time t2 and the time t3 where data input or output via a communication channel to which the electronic device EDEV is connected is a first type of data. The first type of data may be, for example, data only input to the electronic device EDEV such as data for copying a file of a host device to the electronic device EDEV when the electronic device EDEV is plugged into the host device (e.g., input data). In this case, the USB controller UCTL may disable power and a clock signal of the transmission memory TM and the transmitter Tx in response to the power control signal XPM having the second value VLU2, as described with reference to FIG. 6.

Alternatively, the power control signal XPM having the fourth value VLU4 may be generated in a period between the time t4 and a time t5 where data input or output via the communication channel to which the electronic device EDEV is connected is a second type of data. The second type of data may be, for example, data only output from the electronic device EDEV such as ACK packet data indicating that the electronic device EDEV has successfully received data (or package data) from the host device, or NAK packet data indicating that the electronic device EDEV and the host device may not transmit or receive data to and from each other (e.g., output data). In this case, the USB controller UCTL may disable power and a clock signal of the reception memory RM and the receiver Rx in response to the power control signal XPM having the fourth value VLU4, as described with reference to FIG. 7.

The power control signal generating unit XPGU may generate the power control signal XPM having the first value VLU1, the third value VLU3, and a fifth value VLU5 respectively in the period between the time t1 and the time t2, the period between the time t3 and the time t4, and a period between the time t5 and a time t6. During these time periods, data is not input or output to or from the USB controller UCTL. For example, during these time periods, the USB controller UCTL may disable power or a clock signal of the USB physical layer UPL and the transmission/reception memory RTM in response to the power control signal XPM having the first value VLU1, the third value VLU3, or the fifth value VLU5, as shown in FIGS. 5 and 8.

The first value VLU1, the third value VLU3, and the fifth value VLU5 of FIG. 9 may be the same as each other, or similar to each other. Alternatively, the first value VLU1, the third value VLU3, and the fifth value VLU5 of FIG. 9 may be different from each other. Alternatively, the first value VLU1 and the second value VLU2 of FIG. 9 may be the same as or different from the first value VLU1 or the second value VLU2 of FIG. 4.

As described above, referring to the electronic device EDEV, since power management is performed during USB runtime, (e.g., in an active mode), power consumption of the electronic device EDEV may be reduced. In an experimental example, in a state in which data transmission or data reception did not occur in an active mode, implementing power management according to an exemplary embodiment reduced power consumption at a first input pin of the electronic device EDEV by about 10.49%, and reduced power consumption at a second input pin of the electronic device EDEV by about 7.88%.

Since power consumption is reduced when the USB communication channel is idle while the electronic device EDEV is in an active mode according to exemplary embodiments, the use time of the electronic device EDEV may be increased, and the amount of time taken to charge the electronic device EDEV may be reduced. For example, if the electronic device EDEV is a mobile device, a long use time (e.g., a long battery life) may be advantageous. Since there is no change in communication between the electronic device EDEV and a host device connected to the electronic device EDEV, power of the electronic device EDEV or power of a system to which the electronic device EDEV is connected may be reduced without changing a scenario for USB communication.

In addition to the electronic device EDEV implementing power management in an active mode as described above, the electronic device EDEV may also implement power management while in a suspended mode, according to exemplary embodiments.

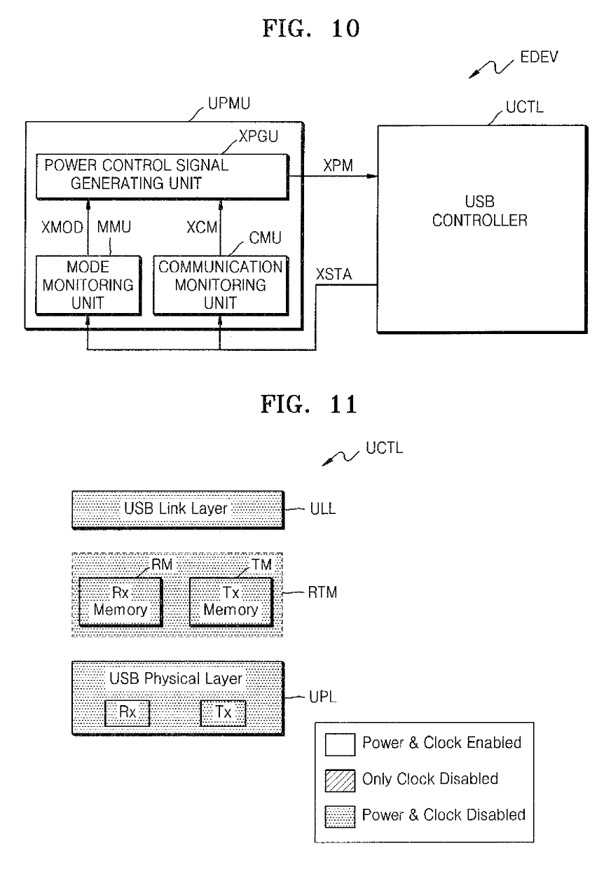

FIG. 10 is a block diagram illustrating an electronic device EDEV according to an exemplary embodiment of the inventive concept. Referring to FIG. 10, the electronic device EDEV includes the USB controller UCTL and the USB power managing unit UPMU, similar to the electronic device EDEV of FIG. 1. The USB controller UCTL and the USB power managing unit UPMU perform the same operations as those of the USB controller UCTL and the USB power managing unit UPMU of FIG. 1, respectively. In addition, the USB power managing unit UPMU of FIG. 10 further includes a mode monitoring unit MMU.

The mode monitoring unit MMU detects an operation mode of the electronic device EDEV or the USB controller UCTL in response to the state signal XSTA. For example, the operation mode of the electronic device EDEV or the USB controller UCTL may be an active mode or a suspended mode. The operation mode of the USB controller UCTL is described herein. When the electronic device EDEV is plugged into a USB port of an external host device, the USB controller UCTL operates in an active mode. In the active mode, data is communicated between the USB controller UCTL and the external host device. When the USB controller UCTL does not operate for a predetermined period of time, the USB controller UCTL may enter a suspended mode. For example, a predetermined idle time may be set, and when the USB controller UCTL is idle for at least the predetermined idle time, the USB controller UCTL may transition from the active mode to the suspended mode.

In certain situations, the USB controller UCTL may be prevented from entering the suspended mode even when there is no data transmission or data reception. This may be accomplished by periodically outputting start of frame (SOF) packet data while in an active mode. The SOF packet data may be output at regular time intervals, each of which is shorter than a time needed to enter a suspended mode. For example, the time intervals may be shorter than the predetermined idle time.

The mode monitoring unit MMU may transmit a mode signal XMOD to the power control signal generating unit XPGU in response to the state signal XSTA. For example, when the mode signal XMOD indicates a suspended mode, the power control signal generating unit XPGU may generate the control signal XPM for disabling power and a clock signal of all functional blocks of the USB controller UCTL in response to the mode signal XMOD, as shown in FIG. 11. When the mode signal XMOD is disabled, the power control signal generating unit XPGU may perform power management in the active mode of FIG. 1 by receiving the communication monitoring signal XCM from the communication monitoring unit CMU.

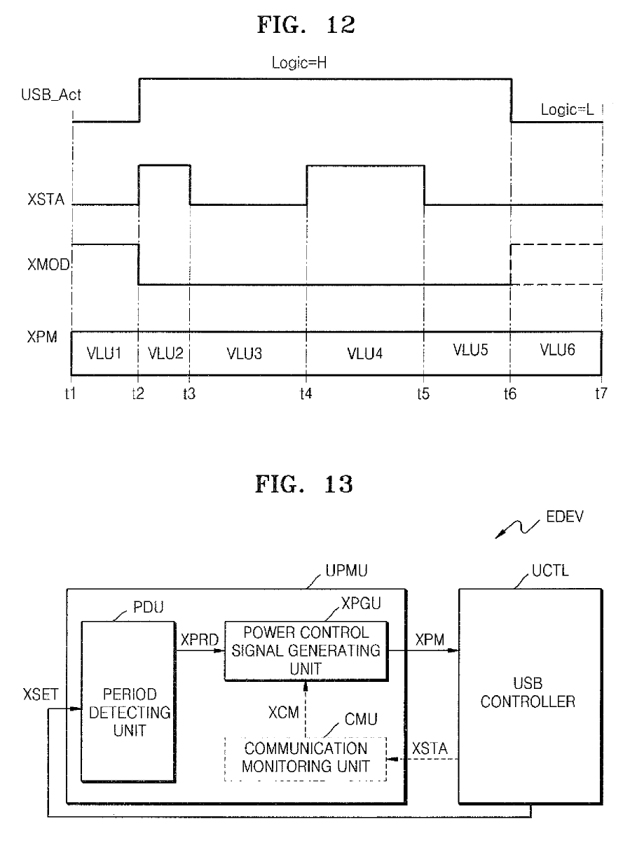

FIG. 12 is a graph illustrating an implementation of power management in the electronic device EDEV of FIG. 10, according to an exemplary embodiment of the inventive concept.

Referring to FIGS. 10 and 12, the USB controller UCTL may operate in a suspended mode until the time t2. As data is input at time t2, the USB controller UCTL may be activated. The power control signal XPM having the first value VLU1 may be transmitted to the USB controller UCTL until time t2. After time t2, the power control signal XPM transmitted to the USB controller UCTL may have other values. For example, in an active mode USB_Act=H (e.g., when USB_Act has a logic high value), the power control signal XPM generated may have the second value VLU2 and the fourth value VLU4 in the period between time t2 and time 13, and the period between time t4 and time 5, respectively. These time periods correspond to a time when data is input or output. In addition, while in the active mode USB_Act=H, the power control signal XPM generated may have the third value VLU3 and the fifth value VLU5 in the period between time t3 and time t4, and the period between time t5 and time t6, respectively. These time periods correspond to a time when data is not input or output.

After time t6, at which the active mode ends and USB_Act=L (e.g., when USB_Act has a logic low value), the power control signal XPM generated may have a sixth value VLU6. When a requirement for entering the suspended mode is satisfied, for example, when the USB controller UCTL does not operate for a predetermined period of time (e.g., a predetermined idle time), the USB controller UCTL may enter a suspended mode XMOD=H (e.g., XMOD has a logic high value) once the active mode ends (e.g., USB_Act=L). In this case, the sixth value VLU6 may be the same as the first value VLU1.

At time t6, at which the active mode ends (e.g., USB_Act=L), when the requirement for entering the suspended mode is not satisfied or another event occurs, the USB controller UCTL may operate in a mode other than the active mode or the suspended mode. For example, when an external host device to which the electronic device EDEV of FIG. 10 is connected enters a power saving mode (e.g., a sleep mode or a partial sleep mode), the USB controller UCTL may operate in another power saving mode.

Although the mode monitoring unit MMU detects a suspended mode in FIG. 12, exemplary embodiments are not limited thereto. For example, the mode monitoring unit MMU may generate the mode signal XMOD indicating an active mode in response to the state signal XSTA, and transmit the mode signal XMOD to the power control signal generating unit XPGU. In this case, the power control signal generating unit XPGU may receive the communication monitoring signal XCM from the communication monitoring unit CMU and perform power management in the active mode of FIG. 1. However, for a period where the mode signal XMOD is disabled, the power control signal generating unit XPGU may recognize an operation mode of the USB controller UCTL as a suspended mode and generate the power control signal XPM for disabling power and a clock signal of all functional blocks of the USB controller UCTL.

FIG. 13 is a diagram illustrating the electronic device EDEV, according to an exemplary embodiment of the inventive concept. Referring to FIG. 13, the electronic device EDEV includes the USB controller UCTL and the USB power managing unit UPMU, similar to the electronic device EDEV of FIG. 1. The USB controller UCTL and the USB power managing unit UPMU of FIG. 13 may perform the same operations as those of the USB controller UCTL and the USB power managing unit UPMU of FIG. 1, respectively.

The USB power managing unit UPMU of FIG. 13 further includes a period detecting unit PDU. The period detecting unit PDU generates a period signal XPRD in response to a set signal XSET. When the electronic device EDEV is connected to an external electronic device via USB, and data is transferred (e.g., a file is copied from the external electronic device to the electronic device EDEV), information regarding an attribute of the electronic device. EDEV and an attribute of the external electronic device may be exchanged between the electronic device EDEV and the external electronic device. The external electronic device connected to the electronic device EDEV may be, for example, a keyboard, a storage device, or a camcorder. In this case, the USB controller UCTL may predict a period corresponding to data transmission for each electronic device. For example, if the external electronic device is a camcorder, data may be transmitted at time intervals of about 10 ms. Alternatively, if the external electronic device is a storage device, data may be expected to be transmitted in longer time intervals. The USB controller UCTL may generate the set signal XSET using the information regarding the attribute of the external electronic device, and transmit the set signal XSET to the period detecting unit PDU.

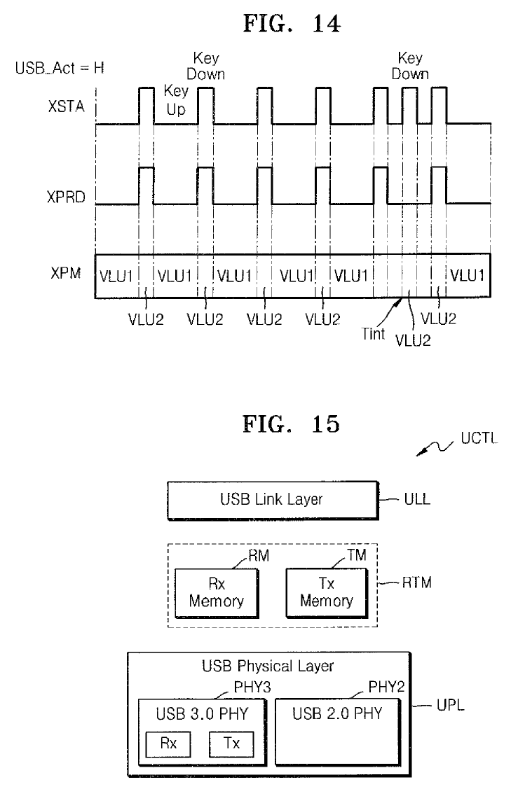

The period detecting unit PDU receives the set signal XSET and generates the period signal XPRD based on the set signal XSET. For example, as shown in FIG. 14, the period signal XPRD may be generated at time intervals corresponding to when a key of a keyboard is pressed (e.g., key down) and not pressed (e.g., key up). When the key is pressed, data may be input to the electronic device EDEV via the communication channel (e.g., via the USB cable).

The power control signal generating unit XPGU may generate the power control signal XPM in response to the period signal XPRD. In FIG. 14, the power control signal generating unit XPGU may generate the power control signal XPM having the first value VLU1 in a period corresponding to the period signal XPRD having a logic low signal (disabled), and generate the power control signal XPM having the second value VLU2 in a period corresponding to the period signal XPRD having a logic high signal (enabled).

The USB controller UCTL may control power or a clock signal of a corresponding functional block such that the functional block is enabled or disabled in response to the power control signal XPM, as described above. For example, as shown in FIG. 14, when the power control signal XPM having the first value VLU1 is generated, power and a clock signal of the transmission/reception memory RTM and the USB physical layer UPL may be disabled, as shown in FIG. 5, or power supplied to the transmission/reception memory RTM and the USB physical layer UPL may be maintained and only a clock signal of the transmission/reception memory RTM and the USB physical layer UPL may be disabled, as shown in FIG. 8.

At a time Tint of FIG. 14, an event that does not correspond to the period signal XPRD may occur. For example, as shown in FIG. 14, a key is pressed (e.g., key down) when the period signal XPRD has a logic low signal (e.g., when the period signal XPRD is disabled). The power control signal generating unit XPGU may receive the state signal XSTA along with the period signal XPRD. Accordingly, the power control signal generating unit XPGU may process the event that does not correspond to the period signal XPRD as an interruption based on the state signal XSTA. In addition, the power control signal XPM having a value corresponding to the interruption may be generated. For example, as shown in FIG. 14, the power control signal XPM having the second value VLU2 may be generated during an interruption period.

FIG. 15 is a diagram illustrating the USB physical layer UPL of FIG. 2, according to an exemplary embodiment of the inventive concept.

Referring to FIG. 15, the USB physical layer UPL may include a USB 3.0 physical layer PHY3, and a USB 2.0 physical layer PHY2. Thus, the USB physical layer UPL may support both USB 3.0 and USB 2.0 standards. USB communication may occur via the USB controller UCTL when an external electronic device connected to the USB controller UCTL operates according to the USB 2.0 or USB 3.0 standard.

According to the USB 3.0 standard, the transmitter Tx and the receiver Rx are separate components. According to the USB 2.0 standard, single channel communication is performed. However, exemplary embodiments of the inventive concept are not limited thereto. Further comparing the USB 3.0 and USB 2.0 standards, according to the USB 3.0 standard, a clock signal may be embedded in data using an 8b/10b encoding method. As a result, communication may be performed without an external reference clock signal by using a single transmission line at a high data transmission frequency. Further, according to the USB 3.0 standard, a period of a reference frequency may be modulated using spread spectrum clocking (SSC), which may reduce or minimize electromagnetic interference (EMI).

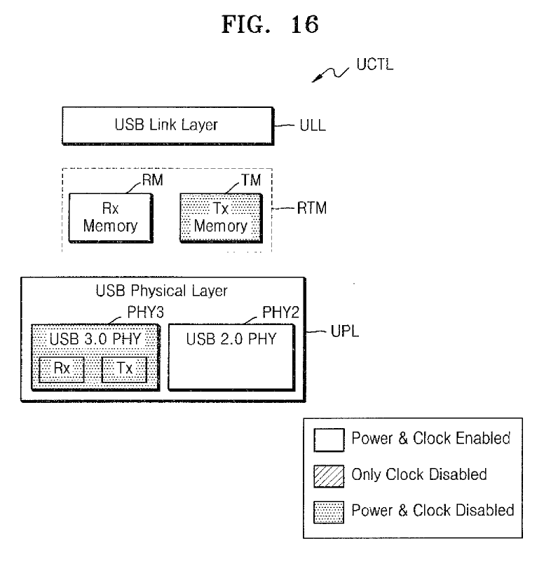

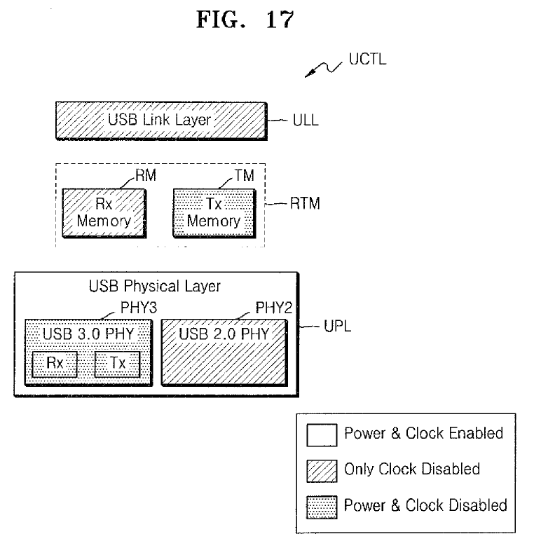

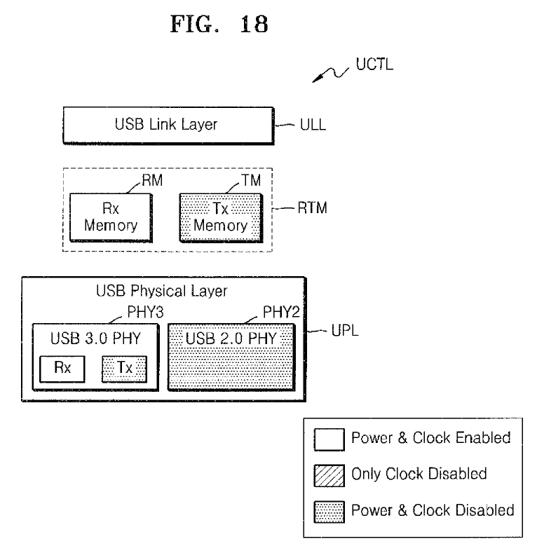

FIGS. 16 through 19 are diagrams illustrating an implementation of power management of the USB controller UCTL of FIG. 15, according to exemplary embodiments of the inventive concept. FIGS. 16 through 19 may show an implementation of power management when the USB controller UCTL is operating in an active mode.

As shown in FIG. 16, when the USB controller UCTL receives data according to the USB 2.0 standard, for example, when the USB controller UCTL receives data from a keyboard or a mouse, the USB controller UCTL may disable power and a clock signal of the transmission memory TM and the USB 3.0 physical memory PHY3. Alternatively, as shown in FIG. 17, when the USB controller UCTL is connected to an external electronic device that communicates according to the USB 2.0 standard, data transmission or data reception does not occur, and data reception is expected after a predetermined period of time, the USB controller UCTL may disable power and a clock signal of the transmission memory TM and the USB 3.0 physical layer PHY3, maintain the power supply to the reception memory RM, the USB 2.0 physical layer PHY2, and the USB link layer ULL, and disable only a clock signal of the reception memory RM, the USB 2.0 physical layer USB PHY2, and the USB link layer ULL.

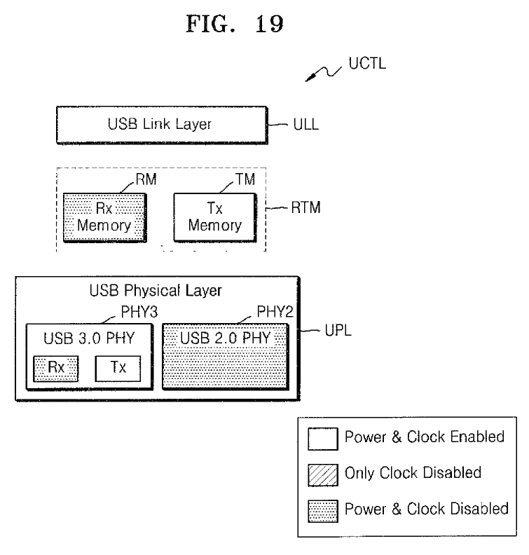

Alternatively, as shown in FIG. 18, when the USB controller UCTL receives data according to the USB 3.0 standard, the USB controller UCTL may disable power and a clock signal of the transmission memory TM, the transmitter Tx of the USB 3.0 physical layer PHY3, and the USB 2.0 physical layer PHY2. Alternatively, as shown in FIG. 19, when the USB controller UCTL transmits data according to the USB 3.0 standard, the USB controller UCTL may disable power and a clock signal of the reception memory RM, the receiver Rx of the USB 3.0 physical layer PHY3, and the USB 2.0 physical layer PHY2. As such, when the USB controller UCTL is in an active mode, since the electronic device EDEV performs power management that is suitable for USB communication, power consumption may be reduced or minimized without affecting USB communication.

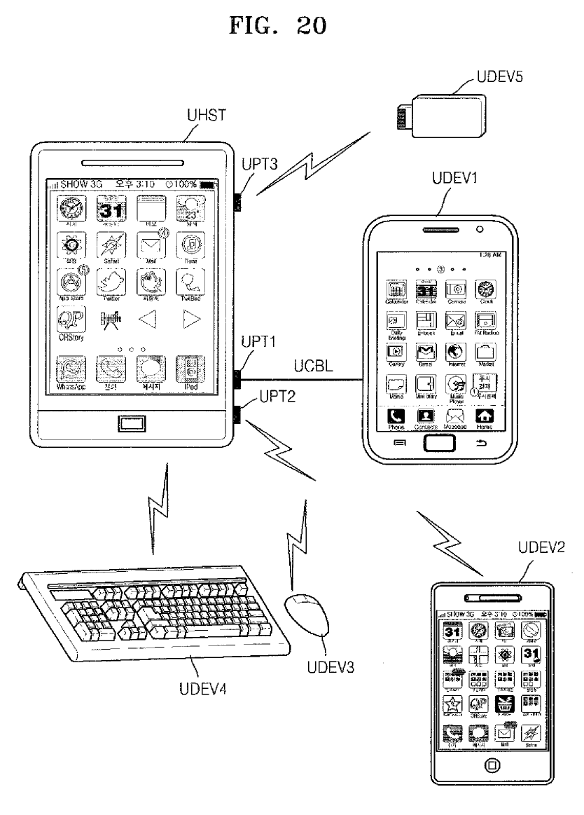

FIG. 20 is a diagram illustrating a system including the electronic device EDEV, according to an exemplary embodiment of the inventive concept.

Referring to FIG. 20, the electronic device EDEV may be a host device UHST, a first electronic device UDEV1 connected to a first port UPT1 of the host device UHST via a wired connection, or a second electronic device UDEV2 connected to a second port UPT2 of the host device UHST via a wireless connection. As described above, data may be input or output via a USB cable UCBL during wired USB communication, and data may be input or output via an ultra-wideband UWB wireless connection during wireless USB communication. When the electronic device EDEV is included in the system of FIG. 20, power consumed by the USB cable UCBL (e.g., a bus) may vary based on whether data is input and/or output.

When the electronic device EDEV is the host device UHST, the USB controller UCTL may operate as a USB host controller. The USB host controller may include a functional block responsible for scheduling allotted data bandwidth or processing all transactions, in addition to functional blocks of the USB controller UCTL.

Alternatively, when the electronic device EDEV is a client device such as the first electronic device UDEV1 or the second electronic device UDEV2, the USB controller UCTL may be a USB device controller. Alternatively, when the electronic device EDEV is the first electronic device UDEV1 or the second electronic device UDEV2, the electronic device EDEV may act as a host device of another electronic device (e.g., a keyboard UDEV4 or a mouse UDEV3). In this case, the USB controller UCTL of the electronic device EDEV may function as both a USB device controller and a USB host controller.

According to various exemplary embodiments of the electronic device EDEV described with reference to FIG. 20, since power management is performed as described above, power consumed by the electronic device EDEV may be reduced. As a result, the overall power consumed by the system in which the electronic device EDEV is included may be reduced.

For example, the electronic device EDEV may be a passive client device such as a USB memory device UDEV5 of FIG. 20. In this case, since the USB memory UDEV5 is supplied with power from a host device connected to the USB memory device UDEV5, when power management is performed in the USB memory device UDEV5 as described above, the amount of power to be supplied to the USB memory device UDEV5 from the host device may be reduced. Although the USB memory device UDEV5 is illustrated as being connected via a wireless connection to a third port UPT3 in FIG. 20, exemplary embodiments are not limited thereto. The USB memory device UDEV5 may input or output data via a wired connection or a wireless connection, and may be connected to another port (e.g., the first port UPT1 or the second port UPT2). In an exemplary embodiment, multiple electronic devices wirelessly communicating with the host device UHST may wirelessly communicate via the same wireless port (e.g., the second port UPT2 or the third port UPT3).

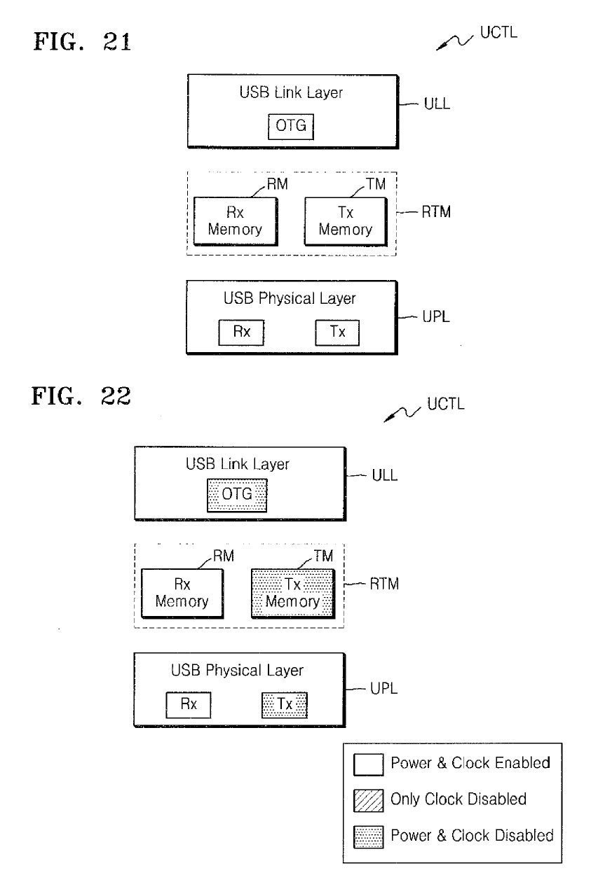

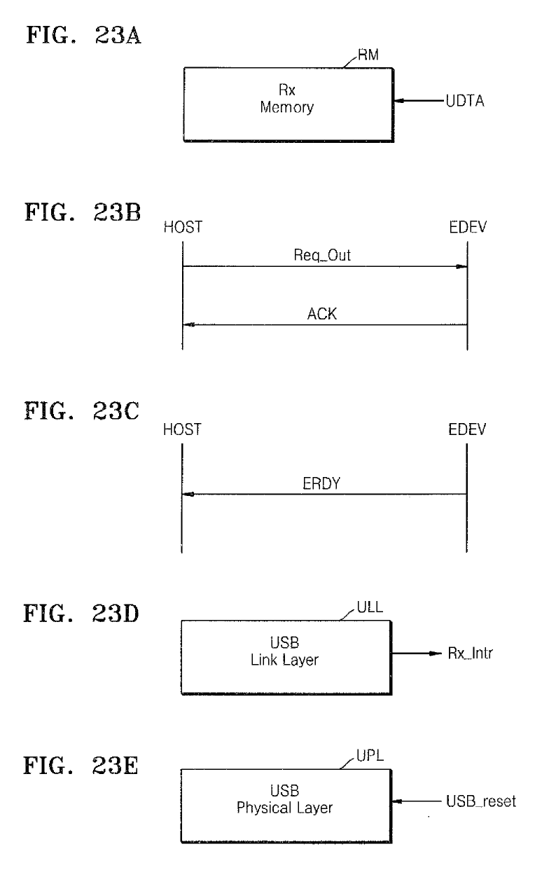

The electronic device EDEV may include a USB on-to-go (OTG) block in the USB link layer ULL, allowing the electronic device EDEV to operate as both a USB client device and a USB host device of another USB client device, as shown in FIG. 21. In order to reduce power consumption when the USB controller UCTL is in an active mode, when the electronic device EDEV functions as a USB client device receiving data via a communication channel, power and a clock signal of the transmission memory TM, the transmitter Tx, and the OTG block may be disabled, as shown in FIG. 22.

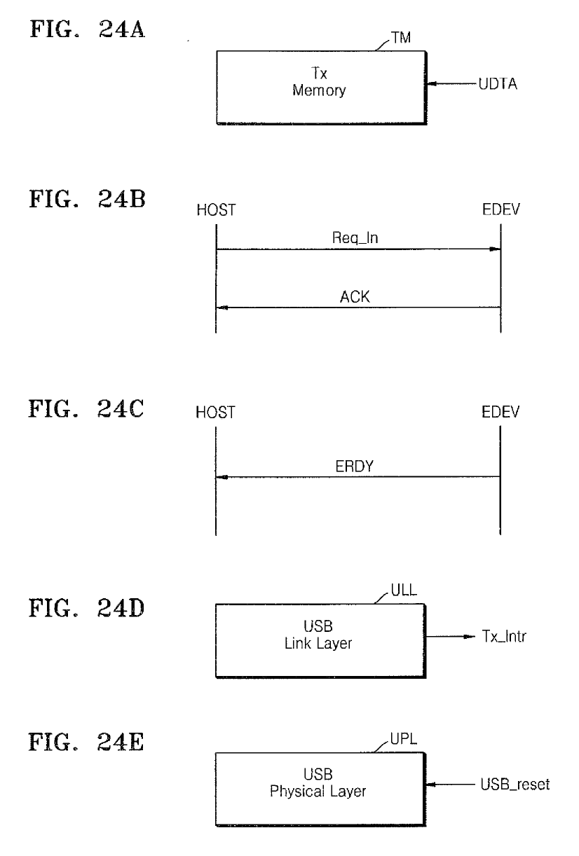

FIGS. 23A through 24E are diagrams illustrating detecting a communication state of the electronic device EDEV, according to exemplary embodiments of the inventive concept.

Referring to FIGS. 1 and 23A through 24E, as described above, the state signal XSTA may include information regarding the communication state between the USB controller UCTL and an external electronic device. For example, when a trigger occurs as shown in FIGS. 23A through 23E, the power control signal generating unit XPGU may determine that the USB controller UCTL receives data from the external electronic device, and may generate the power control signal XPM.

For example, when data UDTA is input to the reception memory RM, as shown in FIG. 23A, or when ACK handshake packet data indicating that the electronic device EDEV has successfully received an output request token signal Req_Out generated when a host HOST needs to transmit control packet data to the electronic device EDEV is input to the host HOST, as shown in FIG. 23B, data may be expected to be input to the USB controller UCTL within a short amount of time.

Alternatively, when the USB controller UCTL requests endpoint ready transaction packet data ERDY as shown in FIG. 23C, when the USB link layer ULL generates a reception interruption signal Rx_Intr, as shown in FIG. 23D, or when the USB physical layer UPL detects a reset signal USB_reset of the USB controller UCTL, as shown in FIG. 23E, data may be expected to be input to the USB controller UCTL within a short amount of time.

In FIGS. 23A through 23E, when the electronic device EDEV does not transmit data while receiving data, the generated power control signal XPM may have a value configured to disable the transmission memory TM and the transmitter Tx of the USB controller UCTL, as described with reference to FIG. 6.

For example, when a trigger occurs as shown in FIGS. 24A through 24E, the power control signal generating unit XPGU may determine that the USB controller UCTL transmits data to an external electronic device, and may generate the power control signal XPM.

For example, when the data UDTA is input to the transmission memory TM, as shown in FIG. 24A, or when ACK handshake packet data indicating that the electronic device EDEV has successfully received an input request token signal Req_In generated when the host HOST needs to receive packet data from the electronic device EDEV is input to the host HOST, as shown in FIG. 24B, data may be expected to be output from the USB controller UCTL within a short amount of time.

Alternatively, when the USB controller UCTL requests the endpoint ready transaction packet data ERDY, as shown in FIG. 24C, when the USB link layer ULL generates the transmission interruption signal Tx_Intr, as shown in FIG. 24D, or when the USB physical layer UPL detects the reset signal USB_reset, as shown in FIG. 24E, data may be expected to be output from the USB controller UCTL within a short amount of time.

In FIGS. 24A through 24E, when the electronic device EDEV does not receive external data while transmitting data, the generated power control signal XPM may have a value configured to disable the reception memory RM and the receiver Rx of the USB controller UCTL, as described with reference to FIG. 7.

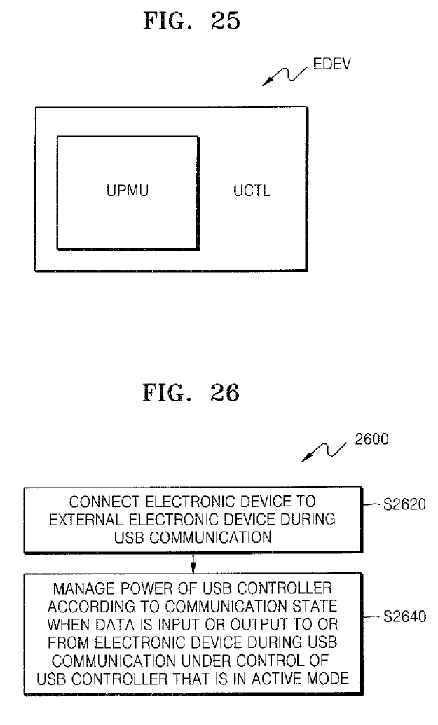

In the electronic device EDEV of FIG. 1, the USB power managing unit UPMU and the USB controller UCTL are separate components. For example, the USB power managing unit UPMU may be disposed on a driver end of the USB controller UCTL. Although the USB power managing unit UPMU and the USB controller UCTL are illustrated as being separate components in FIG. 1, exemplary embodiments are not limited thereto. For example, as shown in FIG. 25, the USB power managing unit UPMU may be included in the USB controller UCTL. In FIG. 25, the USB power managing unit UPMU may be included in some functional blocks from among functional blocks of the USB controller UCTL, may receive the state signal XSTA of FIG. 1 from other functional blocks of the USB controller UCTL, and may transmit the power control signal XPM to other functional blocks of the USB controller UCTL.

FIG. 26 is a flowchart illustrating a method 2600 of managing power of an electronic device, according to an exemplary embodiment of the inventive concept.

Referring to FIG. 26, the electronic device is connected to an external electronic device during USB communication at block S2620. At block S2640, data is communicated between the external electronic device and the electronic device EDEV via a USB controller that is in an active mode.

Block S2640 may include an operation of managing power of the USB controller UCTL according to a communication state, as shown in FIG. 4. As described above, the operation of managing power of the USB controller UCTL may include an operation of varying a level of power supplied to the USB controller UCTL according to whether data is input to, or output from the USB controller UCTL. For example, as shown in FIG. 6, when data is input, power of the transmitter Tx and the transmission memory TM may be disabled.

Alternatively, the operation of varying a level of the power supplied to the USB controller UCTL may include an operation of varying a level of power supplied to the USB controller UCTL according to a type of data input to or output from the USB controller UCTL, as shown in FIG. 9. Alternatively, the operation of managing power of the USB controller UCTL may include an operation of detecting a period at intervals in which data is communicated between the USB controller UCTL and the external electronic device connected to the USB controller UCTL, and varying a level of power supplied to the USB controller UCTL according to the period.

Referring to the period detecting unit PDU of FIG. 13, although the period signal XPRD is shown as being transmitted to only the power control signal generating unit XPGU, exemplary embodiments are not limited thereto. For example, the period detecting unit PDU of FIG. 13 may transmit the period signal XPRD to the communication monitoring unit CMU. In the exemplary embodiments described above, the communication monitoring unit CMU may detect a communication state by periodically performing monitoring in response to the period signal XPRD.

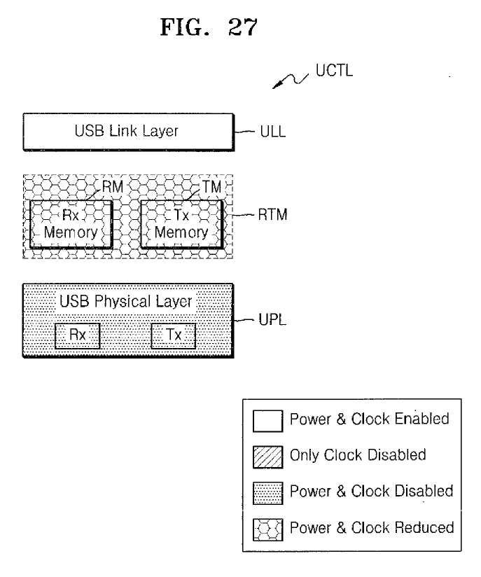

Further, although the USB power managing unit UPMU performs power management on a functional block of the electronic device EDEV by disabling the power supply (for example, see FIG. 5) and/or disabling a clock signal (for example, see FIG. 8), exemplary embodiments are not limited thereto. For example, as shown in FIG. 27, power management may be performed on a functional block (for example, the transmission/reception memory RTM) corresponding to a state of a device by supplying a level of power less than that supplied to the functional block during a normal operation. That is, power management may be performed on a functional block by reducing the level of supplied power in addition to disabling the supplied power.

According to an electronic device and a method of managing power of the same according to exemplary embodiments of the inventive concept, power consumption may be reduced while a communication channel with an external device is in an active state.

While the present invention has been particularly shown and described with reference to the exemplary embodiments thereof, it will be understood by those of ordinary skill in the art that various changes in form and detail may be made therein without departing from the spirit and scope of the present invention as defined by the following claims.

What is claimed is:

1. An electronic device, comprising:
a universal serial bus (USB) controller configured to transmit data to an external electronic device or receive data from the external electronic device during an active mode; and
a USB power managing unit configured to manage power of the USB controller in response to a state signal while the USB controller is operating in the active mode, wherein the state signal is based on a communication state of the USB controller.

2. The electronic device of claim 1, wherein the state signal indicates whether data is being received at the USB controller or transmitted from the USB controller.

3. The electronic device of claim 2, wherein the USB power managing unit is configured to generate a power control signal,
the USB controller is configured to reduce or disable power or a clock signal of at least one functional block of the USB controller utilized for data transmission in response to receiving the power control signal while the state signal indicates that data is being received at the USB controller, and
the USB controller is configured to reduce or disable power or a clock signal of at least one functional block of the USB controller utilized for data reception in response to receiving the power control signal while the state signal indicates that data is being transmitted from the USE controller.

4. The electronic device of claim 2, wherein the USB power managing unit is configured to generate a power control signal, and the USB controller is configured to disable a clock signal and maintain a power supply to at least one functional block of the USB controller utilized for data transmission or data reception in response to receiving the power control signal while the state signal indicates that a communication channel between the electronic device and the external electronic device is in an idle state.

5. The electronic device of claim 1, wherein the state signal indicates a type of data received at the USB controller or transmitted from the USB controller.

6. The electronic device of claim 5, wherein the USB power managing unit is configured to generate a power control signal,
the USB controller is configured to reduce or disable power or a clock signal of at least one functional block of the USB controller utilized for data transmission in response to receiving the power control signal while the state signal indicates that the type of data is input data, and
the USB controller is configured to reduce or disable power or a clock signal of at least one functional block of the USB controller utilized for data reception in response to receiving the power control signal while the state signal indicates that the type of data is output data.

7. The electronic device of claim 1, wherein the USB power managing unit comprises:
a communication monitoring unit configured to receive the state signal and generate a communication monitoring signal indicating the communication state of the USB controller; and
a power control signal generating unit configured to receive the communication monitoring signal, generate a power control signal corresponding to the communication state of the USB controller, and transmit the power control signal to the USB controller.

8. The electronic device of claim 1, wherein the USB power managing unit comprises:
a mode monitoring unit configured to detect an operation mode of the USB controller and generate a mode signal;
a communication monitoring unit configured to receive the state signal and generate a communication monitoring signal indicating the communication state of the USB controller; and
a power control signal generating unit configured to receive the mode signal and the communication monitoring signal, and generate a power control signal corresponding to the communication state of the USB controller.

9. The electronic device of claim 8, wherein the USB controller is configured to disable power and a clock signal of all functional blocks of the USB controller in response to receiving the power control signal while the mode signal indicates that the operation mode of the USB controller is a suspended mode.

10. The electronic device of claim 1, wherein the USB power managing unit comprises:
a period detecting unit configured to generate a period signal in response to a set signal received from the USB controller, wherein the period signal indicates intervals at which data is communicated between the USB controller and the external electronic device; and
a power control signal generating unit configured to generate a power control signal in response to the period signal, wherein the USB controller is configured to periodically reduce or disable power or a clock signal of at least one functional block of the USB controller utilized for data transmission or data reception in response to receiving the power control signal.

11. The electronic device of claim 10, wherein the USB power managing unit further comprises a communication monitoring unit configured to receive the state signal and generate a communication monitoring signal indicating the communication state of the USB controller,
wherein the power control signal is generated in response to the period signal and the state signal while data reception occurs in a period while the period signal is disabled, and power or a clock signal of the at least one functional block utilized for data transmission or data reception of the USB controller is disabled in response to the USB controller receiving the power control signal.

12. The electronic device of claim 1, wherein the USB controller comprises:
a USB link layer configured to perform an encapsulation operation or a de-encapsulation operation according to a USB protocol specification;
a USB physical layer configured to convert parallel data to serial data, or serial data to parallel data, according to the USB protocol specification; and
a transmission/reception memory configured to buffer data and exchange the buffered data between the USB link layer and the USB physical layer.

13. The electronic device of claim 1, wherein the USB controller comprises:
a first physical layer configured to support communication via a USB 3.0 standard; and
a second physical layer configured to support communication via a USB 2.0 standard.

14. The electronic device of claim 13, wherein the USB controller is configured to disable power or a clock signal of the first physical layer in response to receiving a power control signal from the USB power managing unit while the USB controller and the external electronic device are communicating according to the USB 2.0 standard.

15. The electronic device of claim 1, wherein the electronic device is a USB host device and the USB controller is a USB host controller.

16. The electronic device of claim 1, wherein the electronic device is a USB client device and the USB controller is a USB client controller,
wherein the USB power managing unit is configured to generate a power control signal, and the USB controller is configured to disable power and a clock signal of an on-to-go (OTG) block of the USB controller in response to receiving the power control signal while the electronic device is functioning as a host of the external electronic device.

17. The electronic device of claim 1, wherein the USB power managing unit is configured to detect the communication state of the USB controller based on at least one of determining whether data is being input to a reception memory or a transmission memory of the USB controller, determining whether the USB controller is outputting a response signal to an output request signal or is receiving an input request signal from an external host, determining whether the USB controller is transmitting endpoint ready transaction packet data to the external host, determining whether a USB link layer of the USB controller is generating a reception interruption signal or a transmission interruption signal, and determining whether a USB physical layer of the USB controller is detecting a reset signal.

18. The electronic device of claim 1, wherein the electronic device is configured to communicate with the external electronic device via a wired USB connection.

19. The electronic device of claim 1, wherein the electronic device is configured to communicate with the external electronic device via a wireless USB connection.

20. A system, comprising:
a universal serial bus (USB) host device; and
a USB client device,
wherein the USB host device and the USB client device are connected to each other via a USB connection, and
the USB client device comprises a USB power managing unit configured to reduce or disable power or a clock signal of at least one functional block of the USB client device based on a communication state between the USB client device and the USB host device while in an active mode.

21. The system of claim 20, wherein the USB power managing unit is configured to periodically determine the communication state via the USB connection.

22. An electronic device, comprising:
a universal serial bus (USB) controller configured to control data communication between the electronic device and an external electronic device; and
a USB port configured to transmit data to the external electronic device or receive data from the external electronic device under control of the USB controller,
wherein the USB controller is configured to reduce or disable power or a clock signal of a functional block of the USB controller utilized for data reception while data is transmitted from the USB controller to the external electronic device, and reduce or disable power or a clock signal of a functional block of the USB controller utilized for data transmission while data is received at the USB controller from the external electronic device.

23. A method of managing power of an electronic device, comprising:
connecting the electronic device to an external electronic device via a universal serial bus (USB) connection;
transmitting data from the electronic device to the external electronic device, or receiving data at the electronic device from the external electronic device via the USB connection under control of a USB controller of the electronic device; and
reducing power of the USB controller while data is being transmitted from the electronic device to the external electronic device or received at the electronic device from the external electronic device.

24. The method of claim 23, wherein managing power of the USB controller comprises varying a level of power supplied to the USB controller based on whether data is input to or output from the USB controller, or based on a type of data input to or output from the USB controller.

25. The method of claim 24, wherein varying the level of power supplied to the USB controller comprises reducing or disabling power or a clock signal of a functional block corresponding to the communication state from among a plurality of functional blocks included in the USB controller.

26. A method of managing power of an electronic device, comprising:
generating a state signal at a universal serial bus (USB) controller, wherein the state signal indicates a communication state of the USB controller;
transmitting the state signal from the USB controller to a USB power managing unit;
generating a power control signal at the USB power managing unit based on the state signal;
transmitting the power control signal from the USB power managing unit to the USB controller; and
managing power of the USB controller based on the power control signal while the USB controller is in an active mode, wherein the USB controller transmits or receives data while in the active mode.

27. The method of claim 26, wherein managing power of the USB controller comprises reducing or disabling power or a clock signal of at least one functional block of the USB controller utilized for data transmission while data is received at the USB controller, and reducing or disabling power or a clock signal of at least one functional block of the USB controller utilized for data reception while data is transmitted from the USB controller.

28. The method of claim 26, wherein the power control signal comprises a first value corresponding to a state where data is not transmitted from or received at the USB controller, and a second value corresponding to a state where data is transmitted from or received at the USB controller.

29. The method of claim 26, wherein the power control signal comprises a first value corresponding to a state where data is not transmitted from or received at the USB controller, a second value corresponding to a state where a first type of data is transmitted from or received at the USB controller, and a third value corresponding to a state where a second type of data, different from the first type of data, is transmitted from or received at the USB controller.

30. The method of claim 26, further comprising generating a period signal at the power managing unit indicating intervals at which data is transmitted from or received at the USB controller, wherein the power control signal is based on the period signal.
